(19) United States
(12) Patent Application Publication
(10) Pub. No.: US 2014/0362439 A1
(43) Pub. Date: Dec. 11, 2014

(54) DISPLAY DEVICE

(71) Applicant: OS Brand Solutions GmbH, Bochum (DE)

(72) Inventors: Till Schreier, Dortmund (DE); Stephan Overkott, Bochum (DE)

(21) Appl. No.: 14/369,327

(22) PCT Filed: Dec. 14, 2012
(86) PCT No.: PCT/EP2012/075674

§ 371 Date: Jun. 27, 2014

(30) Foreign Application Priority Data
Dec. 28, 2011 (DE) 202011052517.1

(51) Int. Cl. G02B 27/22; G02B 27/14

(52) U.S. Cl. CPC G02B 27/2292; G02B 27/144; G02B 7/182
USPC 359/479

(57) ABSTRACT

The present invention relates to a display device for presenting images or sequences of images in the form of a Pepper's Ghost illusion, comprising a base body (1) with a retainer that has a positioning surface and in which a tablet PC can be positioned in a horizontal position, and two or more partially transparent mirrors (4) which are held against the base body (1) in an inclined position and are disposed parallel to one another so that light radiated by the screen of the tablet PC strikes a reflective surface of the partially transparent mirrors (4) and is proportionately reflected towards the front side in the direction of an observer.

The invention relates to a display device for presenting images or sequences of images in the form of a Pepper's Ghost illusion.

This type of display device is known, for example, from WO 2009/105847. The latter comprises a housing, the inner walls of which are made to be at least partially light-absorbent, as well as a light-generating element which has a light-emitting surface, for example a screen. Furthermore, in order to generate a Pepper's Ghost illusion, a partially transparent mirror is provided, the screen being positioned in front of the mirror and disposed relative to the latter such that light radiated by the screen strikes the partially transparent mirror and a virtual image located behind the mirror or a sequence of virtual images is generated. An observer who directs his glance towards the inclined, partially transparent mirror perceives for example objects which are shown within the framework of the image or the sequence of images floating within the space and he is given a three-dimensional impression.

It is found to be a disadvantage of this display device that it is unwieldy and does not offer sufficient flexibility with regard to the image or sequences of images that can be presented.

Proceeding from this prior art it is an object of the present invention to specify a display device which is configured to be manageable and which can be used flexibly.

This object is achieved by a display device for presenting images or sequences of images in the form of a Pepper's Ghost illusion, comprising a base body with a retainer that has a positioning surface and in which a tablet PC can be positioned in a horizontal position, and two or more partially transparent mirrors which are held against the base body in an inclined position and are disposed parallel to one another so that light radiated by the screen of the tablet PC strikes a reflective surface of the partially transparent mirrors and is proportionately reflected towards the front side in the direction of an observer.

Consequently, the idea underlying the invention is to generate a Pepper's Ghost illusion with the images or sequences of images presented on the screen of a tablet PC. For this purpose the tablet PC is placed in the base body of the display device according to the invention and a sequence of images, for example a video, is played back by the tablet PC. Light that is radiated by the screen of the tablet PC strikes the reflective surface of the partially transparent mirrors held inclined against the base body and is proportionately reflected towards the front side in the direction of an observer. As a result the observer perceives the images or the sequence of images that are played back on the screen of the tablet PC in the form of a Pepper's Ghost illusion, a three-dimensional effect being produced.

The observer does not need to wear any additional aids, such as for example 3D glasses, in order to perceive this effect. The tablet PC or its screen need not be specially equipped either because the Pepper's Ghost illusion is achieved by means of the partially transparent mirror and by means of the specific arrangement. According to the invention a striking effect is brought about for an observer with minimal structural complexity and the use of existing technology. Therefore, the display device according to the invention is particularly suitable for advertising purposes.

According to the invention, a high degree of flexibility is provided here as regards the images and sequences of images to be presented because the latter are provided by means of the screen of a tablet PC which can have any content.

According to the invention two or more partially transparent mirrors are held in an inclined position against the base body or housing and are disposed parallel to one another. Light is thereby thrown from essentially two different regions of the tablet PC screen onto the two partially transparent mirrors. The screen can be controlled such that two different videos are played back in the two regions—which are formed, for example, by the front and the rear half of the screen surface, the observer perceiving said videos, one superimposed over the other, because light is thrown towards him from the two partially transparent mirrors disposed one behind the other at the same time. For example, in the lower half of the tablet PC screen, from which light is thrown onto the rear partially transparent mirror, a video is played back which only presents the background, while the actual video runs in the front half As a result, the three-dimensional effect generated for the observer by the device according to the invention is particularly striking because said observer perceives two sequences of images lying one behind the other and so a depth effect is produced.

Transparent plastic or glass plates, in particular with an appropriate coating, for example, can be used as partially transparent mirrors. Flexible materials, such as for example a thin plastic film with a coating, which is for example stretched out within a frame, can also be used as flexible materials. The partially transparent mirrors can be configured, for example, such that they reflect approximately 50% of the incidental light and transmit approximately 50%. A different ratio of reflection and transmission is also possible.

According to one exemplary embodiment of the present invention provision is made such that the retainer has a guide rail into which the tablet PC can be inserted by means of which secure positioning of the tablet PC in the display device according to the invention is guaranteed. Preferably, the lower support surface of the guide rails can be provided with cushioning here, such as for example a fleece layer.

In a further exemplary embodiment there are provided on the base body socket retainers in which the partially transparent mirrors are or can be inserted from above. Thus, the partially transparent mirrors can be fastened detachably to the base body in a particularly simple way. If the display device is not required the partially transparent mirrors can be removed manually from the base body in order to break apart the display device into a space-saving state, in particular for transportation or for storage.

Moreover, or alternatively, provision can be made such that the partially transparent mirrors are held pivotably against the base body between an operating position and a folded up position. In this way the display device can be folded up conveniently for transportation and space-saving storage. The connection of the partially transparent mirror and the base body is thus maintained. This can be achieved, for example, by the socket retainers being fastened pivotably to the base body.

In a further development of the invention provision is made such that the base body has a closed lower side by means of which high stability of the display device is guaranteed.

A further embodiment is characterised in that there is provided on the top of the partially transparent mirrors a cover disposed substantially parallel to the retainer for the tablet PC and which reaches over the partially transparent mirrors, the cover being disposed, in particular pivotably, in the upper end of the front mirror. The cover can be connected to the base body by side walls and/or by a rear wall such as to form a housing. By means of the cover, the side walls and a rear wall the partially transparent mirror and the tablet PC are protected from external influences during operation.

The housing can have a light-absorbent surface on the inside here. This embodiment guarantees that the presentation of images or sequences of images in the form of a Pepper's Ghost illusion is not disrupted by ambient and/or scattered light. The display device according to the invention can thus be used in particular in brightly lit rooms and in daylight, darkening of the surrounding area not being necessary. For this purpose, the cover, the side walls and the rear wall can be made, for example, of plastic which has a dark surface for better light absorption.

In order to provide additional protection against ambient and scattered light, in a further development of the invention a forwardly projecting blind is provided on the upper side of the housing.

According to one preferred embodiment provision is made such that the housing is substantially in the form of a parallelepiped. By means of this form one takes into account the fact that the partially transparent mirrors are held against the housing in an inclined position.

In one advantageous configuration provision is made such that the cover can be brought together with the base body to form a closed housing, in particular for transportation. Here the cover and the base body are advantageously formed complementarily such that they form a closed housing. In particular, the cover and the base body can be identical in form. In this way one component is used twice and the production sequence is simplified.

If the cover and the base body form a closed housing in the folded up state, the display device according to the invention is also protected from external influences in this space-saving state suitable for transportation and storage. Provision can be made here such that the partially transparent mirror is initially removed from the display device in order to be able to bring together the cover and the base body to form a closed housing. The partially transparent mirror can be stored in the closed housing. Alternatively, the partially transparent mirror is also moved when the cover and the base body are brought together and, as a result of a combined pivoting and sliding movement are automatically brought into a position in which it rests in the base body or in the closed housing formed by the base body and the cover.

In a further development of the invention provision is made such that the partially transparent mirrors are held against the base body or the housing, inclined towards the lower side at an angle of less than 60°, in particular at an angle of 45°. This incline makes is possible for the light radiated by the horizontally disposed tablet PC to be thrown by the partially reflective mirror in the direction of an observer located in front of the display device.

With regard to further advantageous configurations and further developments of the invention reference is made to the sub-claims and to the following description of an exemplary embodiment with reference to the attached drawings. The drawings show as follows:

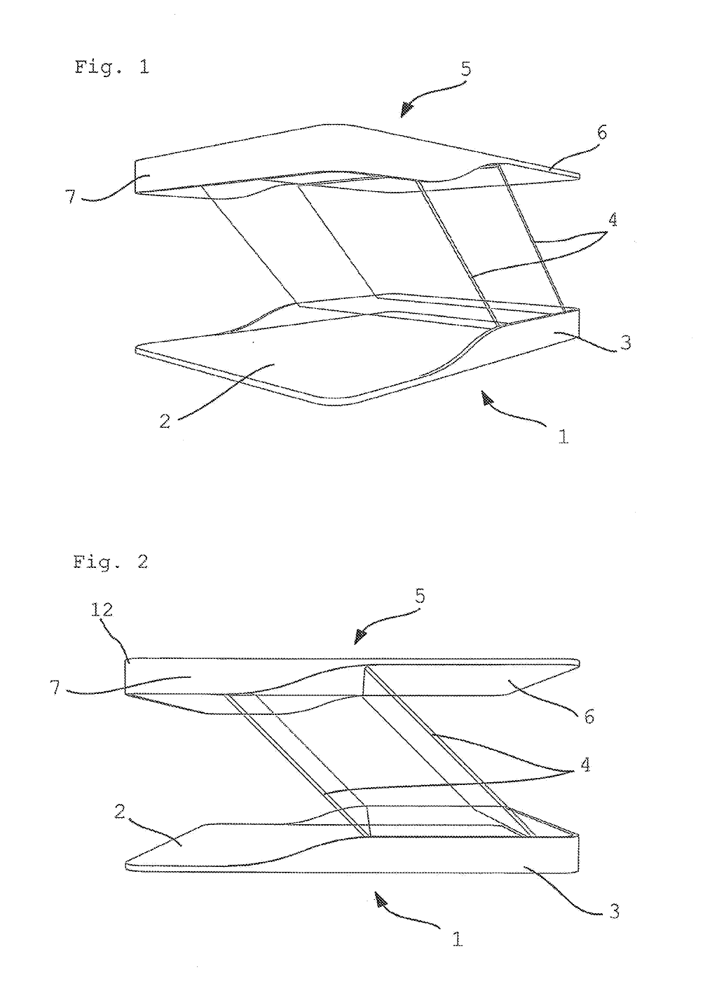

FIG. 1 a diagrammatic illustration of the display device according to the invention with two partially transparent mirrors and a cover from the front and at an angle;

FIG. 2 a side view of the display device shown in FIG. 1;

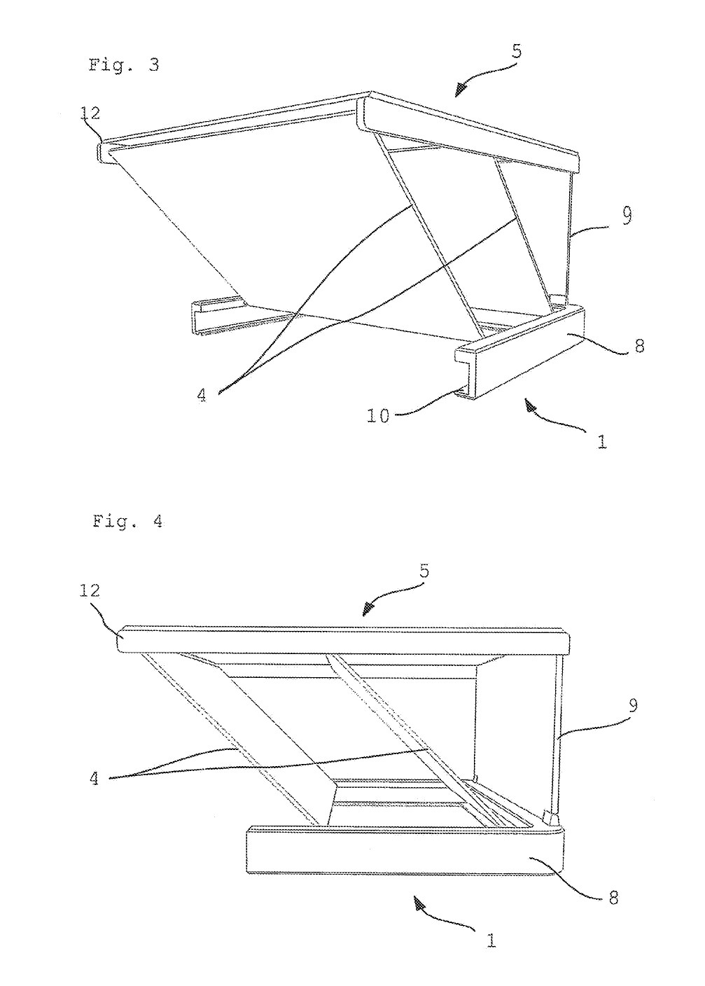

FIG. 3 a diagrammatic illustration of a display device according to the invention with two partially transparent mirrors, a rear wall and a cover, from the front and at an angle;

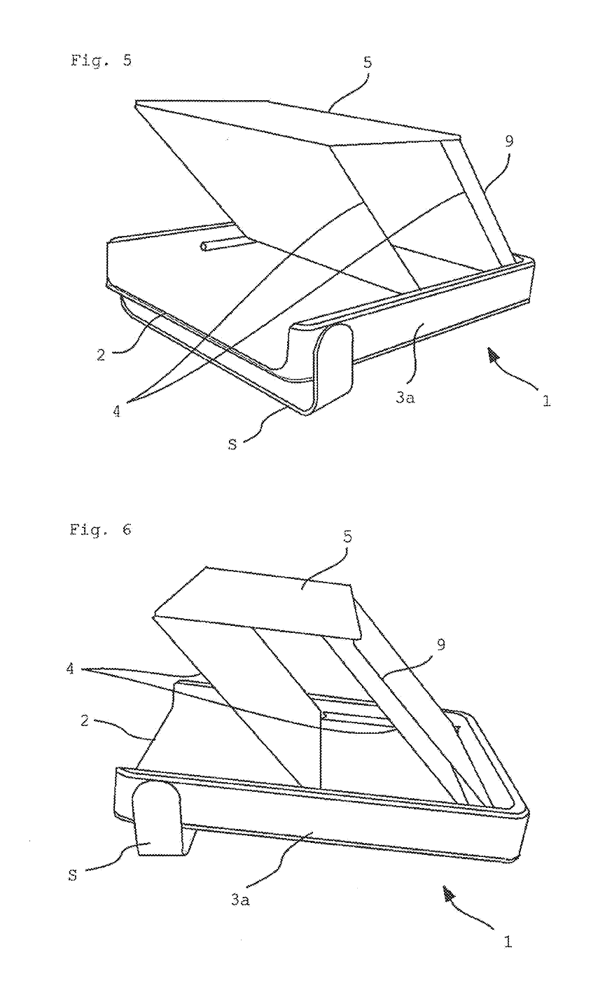

FIG. 4 a side view of the display device shown in FIG. 3;

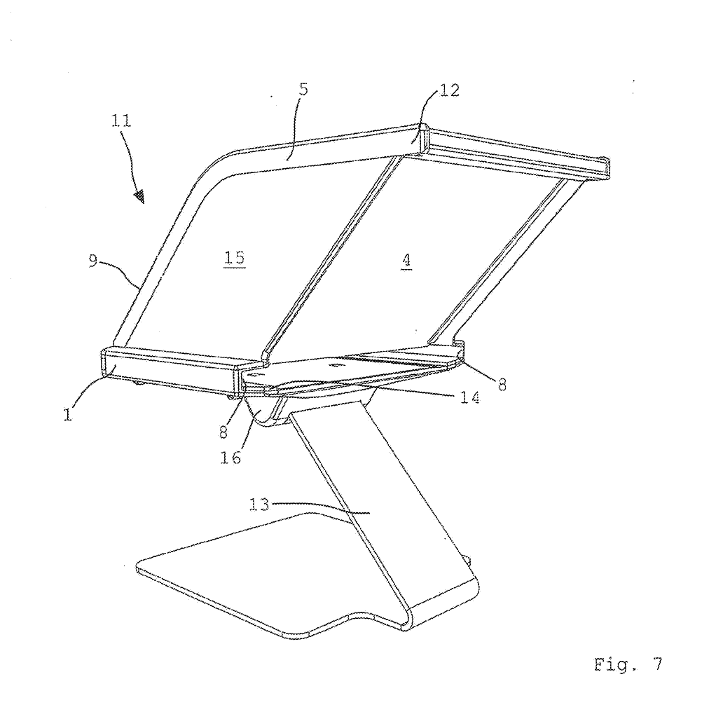

FIG. 5 a diagrammatic illustration of a further display device according to the invention with two partially transparent mirrors, a rear wall and a cover, from the front and at an angle;

FIG. 6 a perspective side view of the display device shown in

FIG. 5;

FIG. 7 a diagrammatic illustration of a further display device according to the invention with a housing, from the front and at an angle;

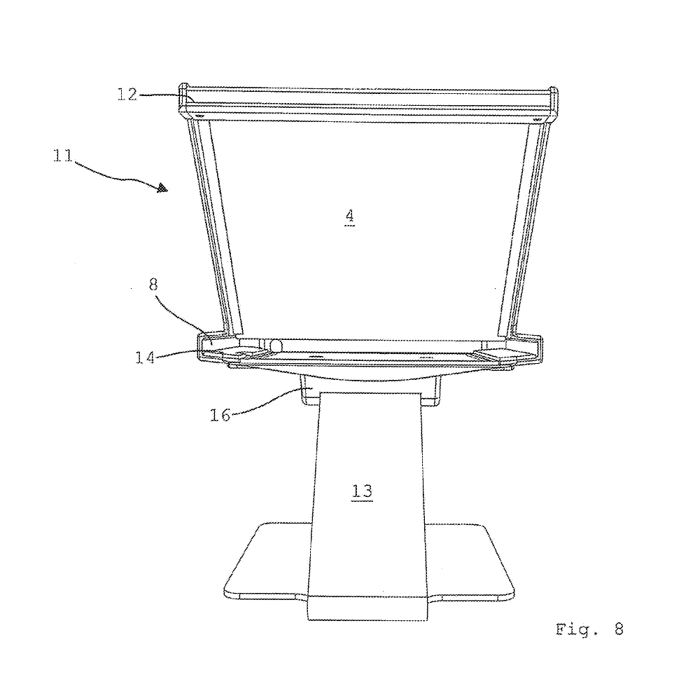

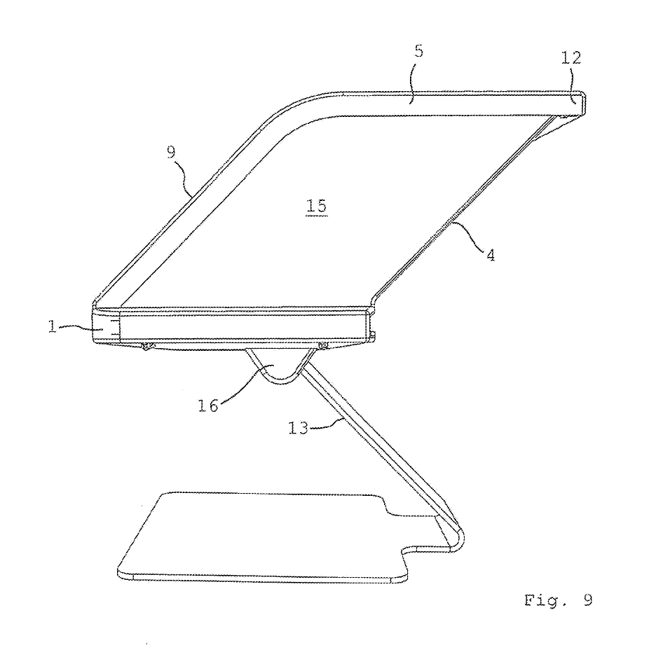

FIG. 8 a front view of the display device from FIG. 7; and

FIG. 9 a side view of the display device shown in FIG. 7.

FIG. 1 shows a display device according to the invention for presenting images or sequences of images in the form of a Pepper's Ghost illusion. Said display device comprises a base body 1 with a substantially rectangular base plate 2, from the peripheral edge of which a bar 3 projects straight upwards. As can be seen well in the figure, the bar 3 extends along the rear face edge and over two thirds of the long sides in the direction of the front face edge of the base plate 2, losing height as it curves from approximately the centre of the plate. The base plate 2 forms together with the bar 3 a retainer in which a tablet PC can be inserted in a horizontal position.

Held against the base body 1 are two partially transparent mirrors 4 which are disposed parallel to one another, inclined at an angle of approximately 45° in relation to the support surface for the tablet PC defined by the base plate 2 so that light radiated by the screen of the tablet PC strikes the reflective surface of the mirrors 4 and is proportionately reflected by the latter towards the front side in the direction of an observer. The coating of the partially transparent mirrors 4 is configured such that approximately 50% of the striking light is reflected and 50% is transmitted.

The display device shown further comprises a cover 5 that is disposed on the upper side of the two partially transparent mirrors 4 and extends substantially parallel to the base plate 2 of the base body 1. The cover 5 is formed complementarily to the base body 1. In other words, the cover 5 also comprises a substantially rectangular base plate 6 from the peripheral edge of which a bar 7 projects straight downwards. Said bar extends along the front face edge and over approximately a third of the long sides in the direction of the rear face edge, losing height as it curves from approximately a quarter of the way along the plate, as can be seen well in the side illustration in FIG. 4. The bar 3 of the base body forms with the bar 7 of the cover a closed circumferential side wall when the base body 1 and the cover 5 lie one over the other.

The cover 5 extends here over the upper edge of the front mirror 4 in the direction of the observer, by means of which a blind 12 is formed which offers protection from scattered and ambient light.

Provided on the cover 5 are socket retainers in which the front partially transparent mirror 4 is inserted and the cover 5 lies on the upper side of the rear partially transparent mirror 4. In the embodiment shown, the cover 5 reaches over the partially transparent mirrors 4 and has a light-absorbent surface facing the partially transparent mirrors 4.

For space-saving storage or for transportation the display device can be broken apart by the cover 5 being lifted off of the partially transparent mirrors 4 and the partially transparent mirrors 4 being removed from the socket retainers of the base body 1. The partially transparent mirrors 4 are positioned flat on the base body 1, and the cover 5 is placed over the latter, a closed housing being obtained due to the complementary form of the base body 1 and the cover 5.

Alternatively to the embodiment shown here, the socket retainers can be held pivotably against the base body 1 and the cover 5 so that the base body 1 and the cover 5 can be brought together by a combined pivoting and sliding movement to form a closed housing. For this purpose, the partially transparent mirrors 4 are brought simultaneously into a horizontal position by a pivoting movement and then the cover 5, the base body 1 and the partially transparent mirrors 4 are pushed together in the horizontal direction so that a closed housing is obtained.

For operation, here too a tablet PC is placed in the retainer of the base body 1 and a video, for example, is played back. Light which is emitted by the front half of the tablet PC strikes substantially the front partially transparent mirror 4, while the light emitted by the rear half of the screen is thrown substantially onto the rear partially transparent mirror 4. The screen is specifically controlled such that separate videos are played back in the two halves of the screen surface. For this purpose an appropriate application is installed on the tablet PC. An observer located in front of the display device perceives the two videos, one superimposed over the other, because light is thrown towards him at the same time by two partially transparent mirrors 4 disposed one behind the other. The screen is controlled here such that in the rear half of the tablet PC screen a video is played back which presents the background, while a main video runs in the front half. As a result, the three-dimensional effect, which the device according to the invention generates for the observer, is particularly striking because the background and the foreground are separated from one another spatially and so a depth effect is produced.

A further configuration of the present invention is shown in FIGS. 3 and 4. This configuration comprises as the base body 1 a U-shaped frame 8 the opening of which points to the front and which has a C-shaped cross-section. Here the frame 8 forms a guide rail into which a tablet PC can be inserted in a horizontal position.

Furthermore, the cover 5 is connected to the base body 1 here by a rear wall 9 which—like the cover 5—has a light-absorbent surface facing the partially transparent mirrors 4.

For operation a tablet PC is inserted into the base body 1 so that it comes to rest against the rear face side of the frame 8 and lies on the lower supporting bar 10 of the frame 8. A Pepper's Ghost illusion is generated for an observer in the way described above. In this embodiment the rear wall 9 offers additional protection from ambient and scattered light.

In FIGS. 5 and 6 a third embodiment of a display device according to the invention is shown. The latter comprises a base body 1 with a base plate 2 which is substantially rectangular in form. Similar to the embodiment described above, a bar 3a projects straight upwards from the peripheral edge of the base plate 2. This bar extends along the rear face edge and over the whole of the long sides of the base plate 2. Together with the bar 3a the base plate 3 forms a retainer in which a tablet PC can be placed in a horizontal position. Furthermore, a substantially U-shaped supporting bar S is provided on the front end region of the base body 1. This supporting bar reaches around the base body 1 on its front side and is held on the outside on the front end region of the bar 3a such as to pivot between an operating and a transportation position. In the figure the holding bar S is in the operating position in which it serves as a foot in the front end region of the base body 1 so that in the tilted position the base body 1 can be placed in a tilted position on a horizontal surface.

Similarly to the embodiments shown in FIG. 1 and FIG. 3 the display device further comprises two partially transparent mirrors 4 which are held against the base body 1 and extend parallel to one another.

Disposed on the upper side of the two partially transparent mirrors 4 is a cover 5 which extends substantially parallel to the base plate 2. However, in this embodiment the cover 5 is not formed complementarily to the base body 1, but is formed by a rectangular plate the extension of which in the longitudinal direction of the display device substantially corresponds to the distance by which the two partially transparent mirrors 4 are held against the base body 1. Here too the cover 5 has a light-absorbent surface facing the partially transparent mirrors 4 and is connected to the base body 1 by a rear wall 9 which extends parallel to the two partially transparent mirrors 4.

The rear partially transparent mirror 4 and the rear wall 9 are held pivotably against the base body 1. For this purpose they have on their lower end region pivot pins which engage in corresponding bore holes on the inside of the bar 3a.

As can be seen well in FIGS. 5 and 6, the front mirror 4 is held pivotably and displaceably on its lower end region in guide grooves which extend on the inside along the long sides of the bar 3a. On its upper end the mirror 4 is connected flexibly to the cover 5 which on its rear end region is attached to the rear wall 9 and the rear mirror 4. For transportation the cover 5 is released on its rear end from the rear wall 9 and the rear mirror 4, and then the two mirrors 4 and the rear wall 9 are pivoted into their almost horizontal position. Here the front mirror 4 is pushed backwards along the guide grooves so that the front mirror 4 and the cover 5a lie totally within the retainer.

It is not shown that the cover 5 can be provided on its front face edge with a forwardly projecting blind.

For operation, similarly to the embodiment described above, a tablet PC is inserted in the retainer of the base body 1 and a video, for example, is played back. A Pepper's Ghost illusion is generated for an observer in the way described above.

In FIGS. 7 to 9 a further embodiment of a display device according to the invention is shown. This display device comprises a closed housing 11 with an open front side which, in the side view, is substantially in the form of a parallelepiped. The housing 11 has a base body 1 which is open to the front side and has two guide rails 8 at the side into which a tablet PC can be inserted in a horizontal position. The support surfaces of the guide rails 8 are provided with cushioning in the form of strips 14 of fleece or felt material. Two side walls 15 project upwards from the base body 1 at the side. Furthermore, there is provided on the rear side of the base body 1 a rear wall 9 which merges into a cover 5. On the inside the housing 11 has a light-absorbent surface, and on the front side of the cover 5 a forwardly projecting blind 12 is provided which protrudes with the front mirror 4 so that it offers protection from scattered and ambient light.

The base body 1 or the housing 11 is fastened to a framework 13 and is held against the latter by a joint 16 such as to pivot about a horizontal axis.

Furthermore, two partially transparent mirrors 4 are held against the housing 11 in an inclined position—also inclined by an angle of 45° in relation to the lower side. Light which is radiated by the tablet PC strikes the reflective surfaces of the partially transparent mirrors 4 and is proportionately reflected towards the open front side of the housing 11.

1. A display device for presenting images or sequences of images in the form of a Pepper's Ghost illusion, comprising a base body (1) with a retainer that has a positioning surface and in which a tablet PC can be positioned in a horizontal position, and two or more partially transparent mirrors (4) which are held against the base body (1) in an inclined position and are disposed parallel to one another so that light radiated by the screen of the tablet PC strikes a reflective surface of the partially transparent mirrors (4) and is proportionately reflected towards the front side in the direction of an observer.

2. The display device according to claim 1, characterised in that the base body (1) has guide rails into which the tablet PC can be inserted, a lower support surface of the guide rails in particular being provided with cushioning such as for example a fleece layer.

3. The display device according to claim 1, characterised in that there are provided on the base body (1) socket retainers in which the partially transparent mirrors (4) are or can be inserted from above.

4. The display device according to claim 1, characterised in that the partially transparent mirrors (4) are held pivotably against the base body (1), at least a front partially transparent mirror (4) being displaceable on the base body (1) so that it can be positioned within the base body (1) by a pivoting movement and a sliding movement.

5. The display device according to claim 1, characterised in that there is provided on the top of the partially transparent mirrors (4) a cover (5) disposed substantially parallel to the retainer for the tablet PC and which reaches over the partially transparent mirrors (4), the cover (5) being disposed, in particular pivotably, on the upper end of the front mirror (4).

6. The display device according to claim 5, characterised in that the cover (5) is connected to the base body (1) by side walls and/or by a rear wall (9) such as to form a housing (11).

7. The display device according to claim 6, characterised in that in the side view the housing (11) is substantially in the form of a parallelepiped.

8. The display device according to claim 7, characterised in that the housing (11) has a light-absorbent surface on the inside.

9. The display device according to 6, characterised in that a forwardly projecting blind (12) is provided on the upper side of the housing (11).

10. The display device according to claim 5, characterised in that the cover (5) can be brought together with the base body (1) to form a closed housing, in particular for transportation.

11. The display device according to claim 10, characterised in that the cover (5) is held against the base body (1) and/or the partially transparent mirrors (4) such that it can be brought together with the base body (1) to form a closed housing by a sliding and/or pivoting movement.

12. The display device according to claim 1, characterised in that the base body (1) has a closed lower side.

13. The display device according to claim 1, characterised in that the partially transparent mirrors (4) are held against the base body (1) or housing (11), inclined by an angle of less than 60°, in particular by an angle of 45° in relation to the positioning surface.

14. The display device according to claim 1, characterised in that the base body (1) is mounted on a foot (13) and is held against the latter, in particular such as to be pivotable about a horizontal axis.

15. The display device according to claim 2, characterised in that there are provided on the base body (1) socket retainers in which the partially transparent mirrors (4) are or can be inserted from above.

16. The display device according to claim 2, characterised in that the partially transparent mirrors (4) are held pivotably against the base body (1), at least a front partially transparent mirror (4) being displaceable on the base body (1) so that it can be positioned within the base body (1) by a pivoting movement and a sliding movement.

17. The display device according to claim 3, characterised in that the partially transparent mirrors (4) are held pivotably against the base body (1), at least a front partially transparent mirror (4) being displaceable on the base body (1) so that it can be positioned within the base body (1) by a pivoting movement and a sliding movement.

18. The display device according to claim 2, characterised in that there is provided on the top of the partially transparent mirrors (4) a cover (5) disposed substantially parallel to the retainer for the tablet PC and which reaches over the partially transparent mirrors (4), the cover (5) being disposed, in particular pivotably, on the upper end of the front mirror (4).

19. The display device according to claim 3, characterised in that there is provided on the top of the partially transparent mirrors (4) a cover (5) disposed substantially parallel to the retainer for the tablet PC and which reaches over the partially transparent mirrors (4), the cover (5) being disposed, in particular pivotably, on the upper end of the front mirror (4).

20. The display device according to claim 4, characterised in that there is provided on the top of the partially transparent mirrors (4) a cover (5) disposed substantially parallel to the retainer for the tablet PC and which reaches over the partially transparent mirrors (4), the cover (5) being disposed, in particular pivotably, on the upper end of the front mirror (4).
